(19) United States
(12) Patent Application Publication
(10) Pub. No.: US 2008/0065591 A1
(43) Pub. Date: Mar. 13, 2008

(54) Configurable software database parallel query system and method

(76) Inventor: Leon Guzenda, Rio Vista, CA (US)

Correspondence Address: PATRICK REILLY, P.O. BOX 7218, SANTA CRUZ, CA, 95061-7218, US

(21) Appl. No.: 11/517,945

(22) Filed: Sep. 8, 2006

(51) Int. Cl. G06F 17/30

(52) U.S. Cl. 707/2

(57) ABSTRACT

A system and method for generating and performing parallel queries of a software database are provided, wherein the software database is distributed within a plurality of localized databases. The system may include several components, to include a user query interface. The user generates and transmits a query to a parallel query engine by means of the user query interface. The parallel query engine tasks a plurality of search agents with the query in accordance with a configurable task splitter. The task splitter is configurable by a system administrator whereby the parallel query process may be designed to conform to locally imposed or desired criteria. Each search agent than searches through an assigned or associated localized database for data elements, such as software objects, that meet both the query and the task splitter criteria. One or more search agents may optionally function in accordance with a database specific filter, wherein data elements matching the query and the task splitter criteria must additionally meet the filter criteria before communication from the search agent to the user query interface.

### FIELD OF THE INVENTION

The present invention relates to information technology systems maintain software databases and enable searching for information within a software database. More particularly, the present invention relates to executing parallel searches of a database by two or more automated search agents.

### BACKGROUND OF THE INVENTION

A software database is a collection of information stored in an information technology system in a systematic way, such that a user may employ a computer to retrieve information from the database. A software program used to manage and query a software database is known as a database management system (hereafter “DBMS”).

In the conventional art, most databases are organized as either a relational database or as an object-oriented database. A relational database (hereafter “RDBS”) stores data in a structure consisting of one or more tables of rows and columns, which are typically interconnected. Each RDBS row corresponds to a record, i.e., a tuple, and each RDBS column correspond to an attribute, i.e., a field, in a record. A Structured Query Language (hereafter “SQL”) is used for data definition, data management, and data access and retrieval from a RDBS.

An object oriented database (hereafter “OODBS”) is based on the object oriented software data model. Instantiating and using an OODBS requires aspects of traditional DBMS, semantic data modeling and object oriented programming languages.

Many public and private enterprises maintain federated databases enabled by information technology infrastructures that support numerous databases. In a federated database system, a client query application can generate a single query to retrieve data matching the query that is distributed across multiple database management systems and then provide the retrieved data to a user as if the retrieved were locally stored. For example, a federated database might include combination of (1.) an object oriented database as marketed by Objectivity, Inc., of Sunnyvale, Calif.; (2.) an IBM DB2 Universal Database (TM) server (in Linux, UNIX (R)) marketed by IBM Corporation of Armonk, N.Y.; (3.) WINDOWS TM operating system environments marketed by Microsoft Corporation of Redmond, Wash.; and (4.) multiple data sources to which the client query application sends queries.

One or more individual databases of a federated database may be managed from and/or stored upon a dedicated server according to various distinctions, to include (1.) by type of information stored in each record, e.g., visual image data, text representations, and audio data, (b.) by record species, e.g., email, invoices, and medical records, (c.) by operational unit, e.g., subsidiary, department and functional team, and (d.) by geography or nation, e.g., North America, France, and the European Community.

Searching an extensive federated database may be made more time efficient by tasking several search agents to simultaneously apply the same query to different individual databases. In the conventional art, each individual database may be searched by a dedicated search agent, wherein each search agent is tasked with matching the same query as generated by the client query application with data stored in an individual database associated with the search agent. Yet the prior art fails to enable a system administrator or application designer to optimize the task assignment of the search agents in light of rules independent of the rules enforced by the DBMS.

The object of the method of the present invention is to provide an improved method for parallel searching.

### SUMMARY OF THE INVENTION

In light of this object, and other objects that will be made obvious in light of the present disclosure, a method for searching a plurality of individual databases is provided. According to a first alternate preferred embodiment of the method of the present invention, a federated data base management system includes a client query application, a parallel query engine, a distributed shared queue, a plurality of databases and a plurality of search agents. The parallel query engine includes a user configurable search task splitter.

In certain alternate preferred embodiments of the method of the present invention, one or more search agents are associated with a user configurable filter, whereby data contained within an associated database that matches a query may be withheld from communication from the database in accordance with one or more filter parameters and rules of the user configurable filter.

In certain still alternate preferred embodiments of the method of the present invention, a computational system is provided having a computer-readable medium. The computer-readable medium comprises machine-executable instructions that enable a computational device to execute one or more steps of the method of the present invention.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a schematic diagram of an information technology infrastructure that supports a federated database;

FIG. 2 is a block diagram of a user computer system of the information technology infrastructure of FIG. 1 that enables a parallel searching technique in accordance with a first alternate preferred method of the present invention;

FIG. 3 is a block diagram of a server of the information technology infrastructure of FIG. 1 that enables a parallel searching technique in accordance with a first alternate preferred method of the present invention;

FIG. 4 is a flow chart showing an operation of a parallel search in accordance with the first alternate preferred embodiment of the method of the present invention;

FIG. 5 is a flow chart of the a customization of the task splitter of FIG. 2 in accordance with the first alternate preferred embodiment of the method of the present invention;

FIG. 6 is a flow chart of a configuration of the user configurable filter of FIG. 3; FIG. 7 is a format diagram of the query statement generated by the parallel query engine of FIG. 2;

FIG. 8 is a schematic diagram of the host processor of FIG. 2; and

FIG. 9 is a schematic of a second alternate embodiment of the method of the present invention.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

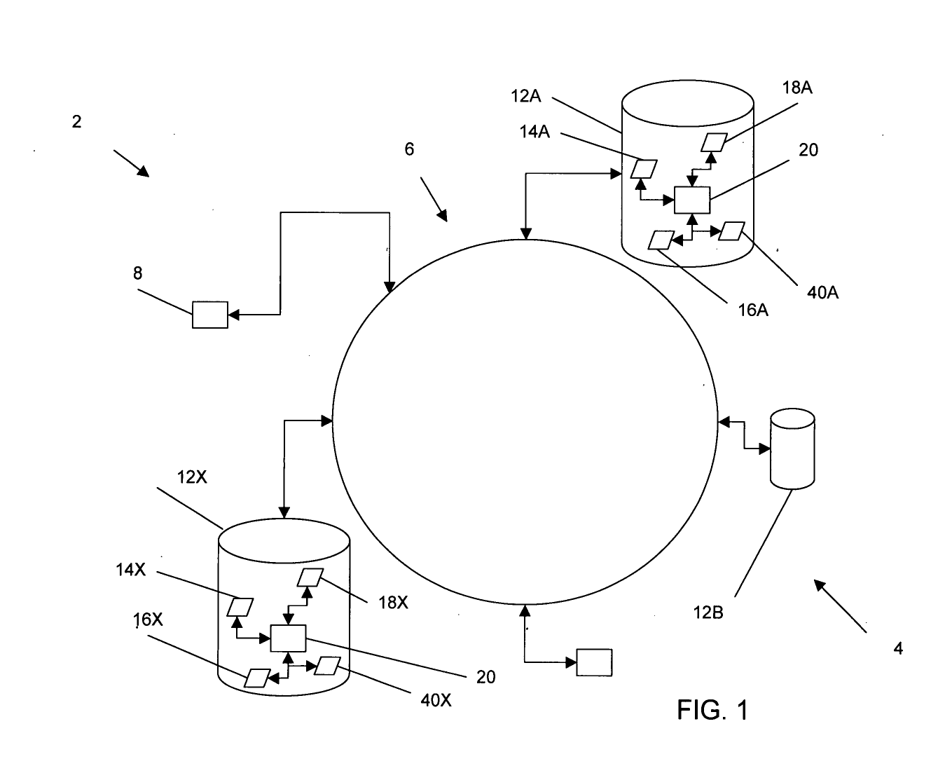

Referring now generally to the Figures and particularly to FIG. 1, FIG. 1 is a schematic diagram of an information technology infrastructure 2 that supports a federated database 4. The information technology infrastructure 2 (hereafter “IT network” 2) includes an electronic communications network 6, a user computer system 8, an administration computer system 10, and a plurality of database equipment 12A-12X, i.e. database servers 12A-12X. It is understood that the IT network 2 and the federated database 4 may wholly or partially comprise, or be comprised within, the Internet.

The user computer system 8, or query system 8, transmits queries to the database servers 12A-12X via the communications network 6. Each database server 12A-12X is configured to maintain and search at least one local database 14A-14X of the federated database 4, and each database server 12A-12X further comprises at least one local search agent 16A-16X. One or more local database 14A-14X may associate one or more pluralities of data structures into containers, wherein each container comprises a subset of the data structures, e.g., software objects, of a local database 14A-14X.

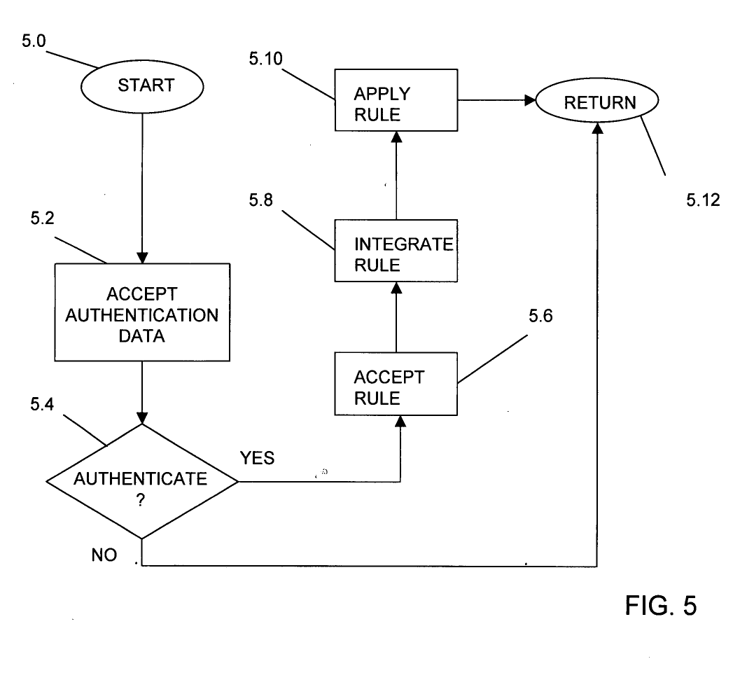

As described below in particular reference to FIG. 5, one or more database servers 12A-12X may each further comprise a configurable software filter 18A-18X, wherein the filters 18A-18X may apply parameters according to filter rules that may affect the communication of search findings from one or more data base servers 12A-12X to the query system 8.

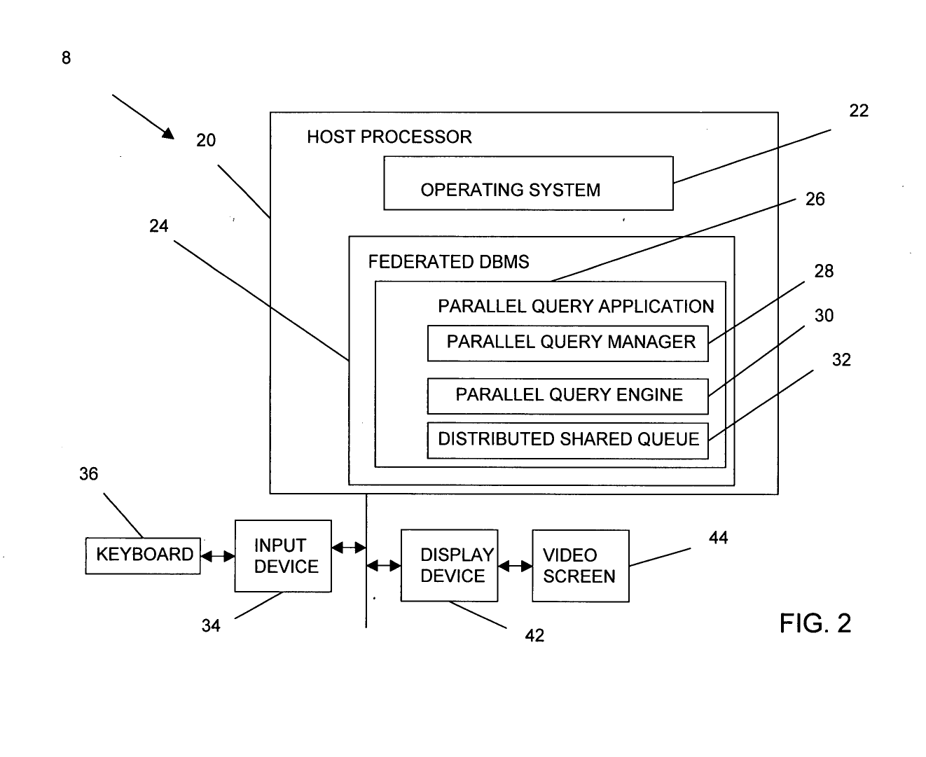

Referring now generally to the Figures and particularly to FIG. 2, FIG. 2 is a block diagram of the query system 8 of the IT network 2 of FIG. 1. The query system 8 may comprise, or be comprised within, (1.) a personal computer configured for running WINDOWS XP TM operating system marketed by Microsoft Corporation of Redmond, Wash., (2.) a computer workstation configured to run, and running, a LINUX or UNIX operating system, or (3.) other suitable computational system known in the art. The query system 8 includes hardware elements and software components that enable a parallel searching technique in accordance with the first alternate preferred method of the present invention (hereafter “first method”). A host processor 20 of the query system 8 stores an operating system 22, a federated DBMS 24 including a parallel query application 26. The parallel query application 26 includes a client parallel query manager 28, a parallel query engine 30, and a distributed shared queue 32. The client query manager 28 accepts input from a user via an input device 34, e.g., an electronic computer peripheral keyboard 36, and generates a query statement Q therefrom, as described below in reference to FIG. 7. The query statement Q is provided to the parallel query engine 30 by the host processor 20. The parallel query engine 30 assigns the query statement Q to a plurality of search agents 16A-16X of the database servers 12A-12X, and in accordance with a set of rules applied by a user configurable task splitter 38 of the parallel query engine 30. The parallel query engine 30 then provides the query statement Q to the client query manager 28, wherefrom the query statement Q is communicated to the plurality of database servers 12A-12X via the communications network 6. Findings communicated from the database servers 12A-12X sent in response to the receipt and processing of the query statement Q are communicated from the data base servers 12A-12X via the communications network 6 to the distributed shared queue 32 of the host processor 20.

It is understood that the administration computer system 10, and the plurality of database servers 12A-12X may comprise a host processor 20 that (a.) does not include the federated DBMS 24 nor the parallel query application 26, and (b.) is bi-directionally communicatively coupled with the electronic communications network 6. It is further understood that in yet other alternate preferred embodiments of the method of the present invention the steps disclosed herein could be directly or indirectly invoked by communication with an application program on behalf of one or more other computer programs running on a computational system and without human interaction.

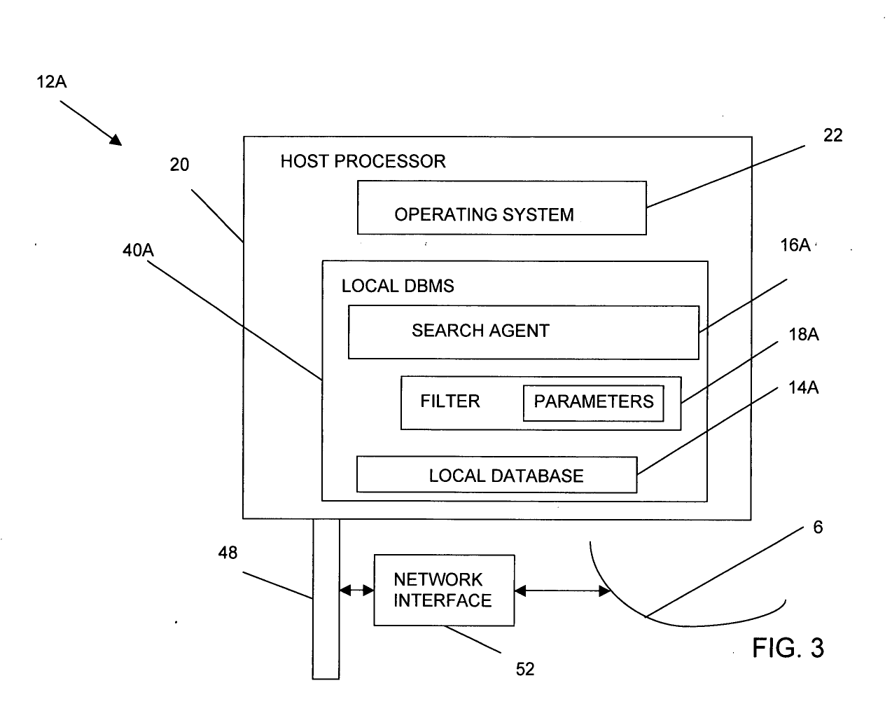

FIG. 3 is a block diagram of a database server 12A-12X of the IT network 2 of FIG. 1 that enables the parallel searching technique in accordance with a first alternate preferred method of the present invention. One or more database servers 12A-12X may comprise, or be comprised within, (1.) a SOLARIS SPARCSERVER computer workstation marketed by Sun Microsystems of Santa Clara, Calif. running LINUX or UNIX operating system, (2.) other suitable computational system configured to run, and running, a LINUX or UNIX operating system, or (3.) other suitable computational system known in the art.

Each database server 12A-12X includes hardware elements and software components that enable a parallel searching technique in accordance with the first method. A host processor 20 of each database server 12A-12X stores an operating system 22, a local DBMS 40A-40X including a local database 14A-14X, a local search agent 16A-16X, and a local software filter 18A-18X. Each filter 18A-18X contains a set of local filter parameters 41A-41X applied by the local software filter 18A-18X to inhibit communication of data structures of the local database 14A-14X. Those data structures that are selected as matching the ranges .x and predicates .x of the query statement Q in a search of the local database 14A-14X performed by the local search agent 16A-16X, and that are not inhibited from communication to the query system 8 by the filter 18A-18X, are communicated via the communications network 6 to the distributed shared queue of the query system 8.

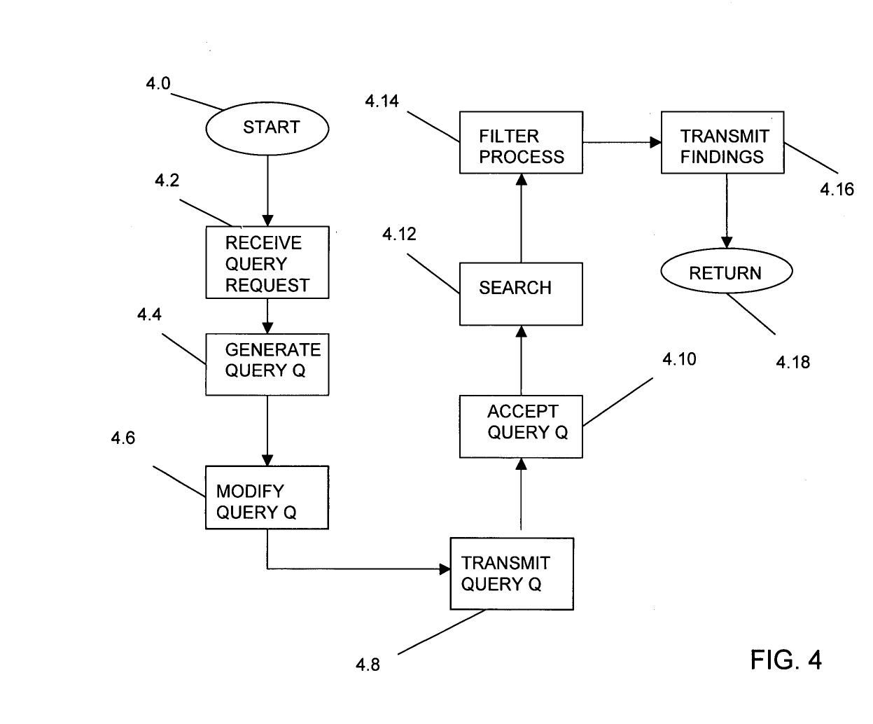

Referring now generally to the Figures and particularly to FIG. 4, FIG. 4 is a flow chart showing an operation of a parallel search in accordance with the first method. In step 4.2 the host processor 20 receives a query request from a user via the input device 34. The user will typically provide search range and predicate information in the query request. For example, a query request may contain one or more ranges of the federated database to be searched, e.g., data more recent than one week and found in an archived email message; and/or one or more predicates, e.g., documents associated with a zoo, a zebra, and/or containing visual image data representing a red hat. In step 4.4 the query manager 28 generates a query statement Q containing the search range and predicate information contained in the query request, and optionally a Boolean algorithm expressing the predicate(s) and/or range of the query request. In step 4.6 the parallel query engine 30 modifies the query statement Q and/or assigns the query statement Q for communication to one or more search agents 16A-16X in accordance with a set of rules of the task splitter 38, wherein at least one of which rules may have been configured and supplied to the query engine 30 by a system administrator, or other authorized agent. In step 4.8 the host processor 20 transmits the query statement Q as modified by the query engine 30 in step 4.6 in accordance with the rules of the task splitter 38 to one or more database servers 12A-12X.

A local DBMS 40A-40X and/or a local search agent 16A-16X of a database server 12A-12X accepts the query statement Q in step 4.10. In step 4.12 the search agents 16A-16X of each database server 12A-12X search one or more databases 14A-14X stored within or accessible to a database server 12A-12X. It is understood that in certain alternate preferred embodiments of the first method one or more of the individual databases 14A-14X may comprise, or be comprised within, a relational database, a object oriented database, and/or other suitable database structures or schema known in the art.

In optional step 4.14 the search agents 16A-16X provide data structures of at least one database 14A-14X, i.e., software objects and/or sequentially stored data records of a database 14A-14X that match the search criteria of the query statement Q, to one or more database filters 18A-18X of the individual DBMS 40A-40X. It is understood that each data structure includes a unique identifier and at least one data element. In step 4.16 the database filter 18A-18X applies filter rules to the data structures provided in step 4.14, and inhibits the database servers 12A-12X from transmitting data structures in accordance with filter rules and parameters 41A-41X. For an example of an inhibiting filter rule, a database filter 18A-18X may by programmed to inhibit transmission of any documents that include a text word parameter, e.g., “birthing”, in any search directed by a query statement Q containing a user authorization level below a certain priority level.

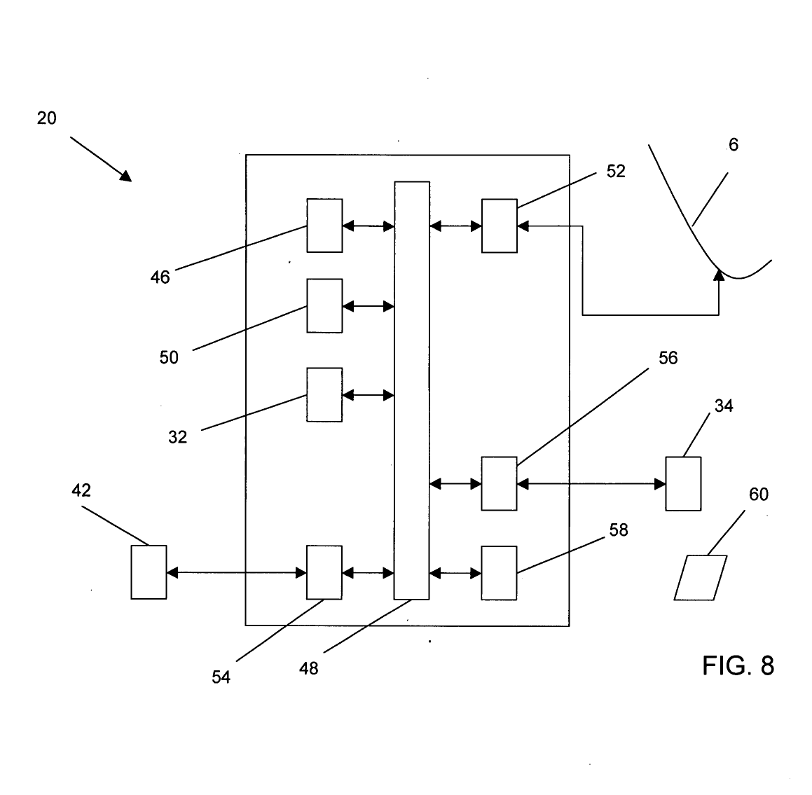

In step 4.16 data structures provided after the optional filtering step of step 4.14 are communicated from the database servers 12A-12X via the communications network 6 to the distributed shared queue 32 of the host processor 20. In step 4.18 the client query manager 28 presents the data structures received in step 4.16 to the client by means of a display device 42, e.g., a video screen 44, as per FIGS. 2 and 8.

Referring now generally to the Figures and particularly to FIG. 5, FIG. 5 is a flow chart of the a customization of the task splitter 38 of FIG. 2 in accordance with the first alternate preferred embodiment of the method of the present invention. In step 5.2 the system administrator (hereafter “sys admin”) initiates authentication by providing a user name and a password to a host processor 20 of either the administration computer system 10 and/or the query system 8 via the input device 34. In step 5.4 the host processor 20 compares the user name and password provided in step 5.2 with a user name and password stored in the administration computer system 10. In step 5.6 the host processor 20 accepts a task splitter rule as provided via the input device 34 by the sys admin.

One exemplary task splitter rule provide in step 5.6 might direct the task splitter 38 to interpret a query range or scope “Europe” as meaning a list of 49 databases named “Albania”, “Austria” thru “Vatican City”.

In step 5.8 the host processor 20 integrates the rule provided in step 5.6 into the rules of the task splitter 38 by means of (1.) the query system 8 and/or (2.) the communications network 6 and the administration computer system 10. In step 5.10 the task splitter 38 applies the rule provided in step 5.6 to the processing of a query statement Q. In step 5.12 the host processor 20 of the query system 8 returns to alternate processes.

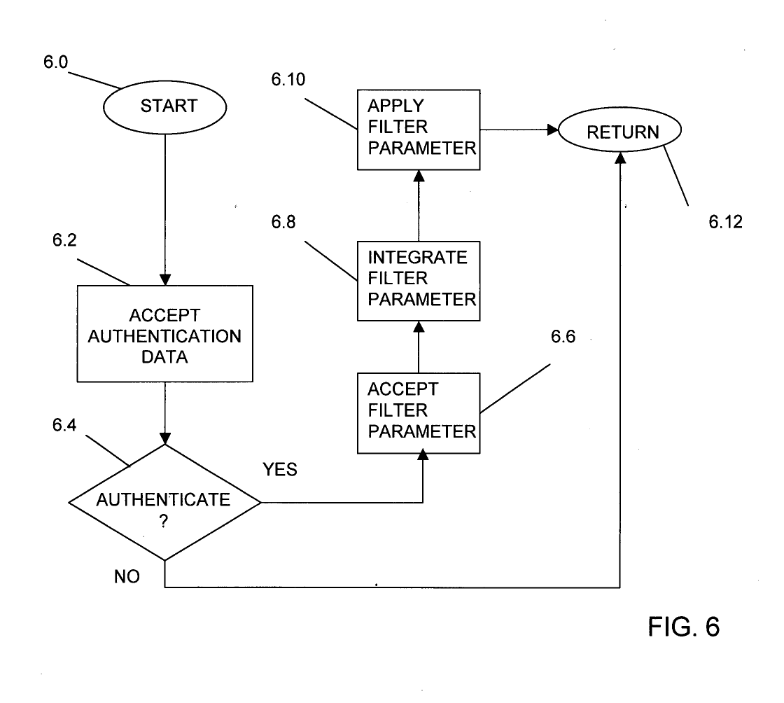

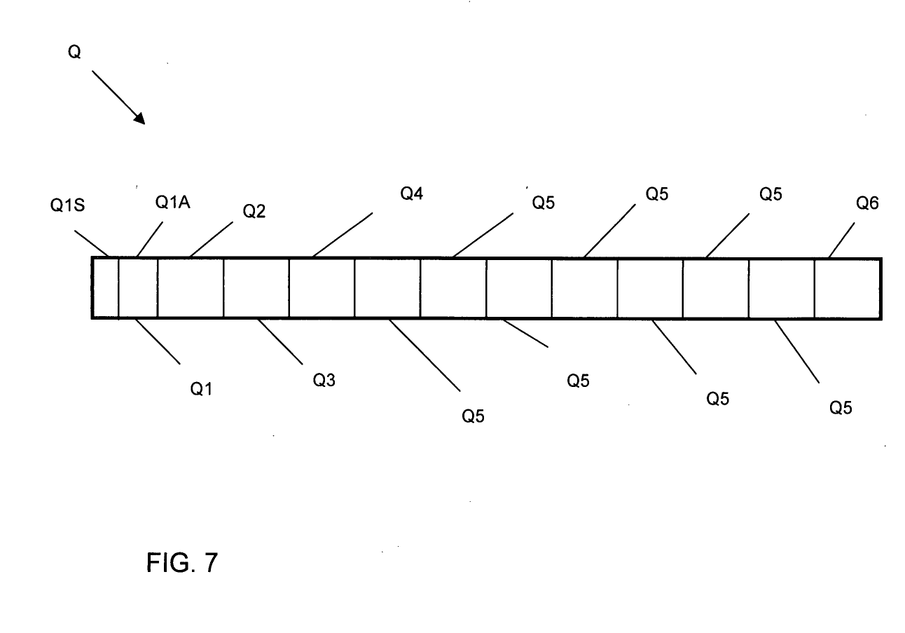

Referring now generally to the Figures and particularly to FIG. 6, FIG. 6 is a flow chart of a second alternate preferred embodiment of the method of the present invention wherein a sys admin may configure a filter 18A-18X of a search agent 14A-14X of a database server 12A-12X of FIG. 1. In step 6.2 the sys admin initiates authentication by providing a user name and a password to a host processor 20 of a database server 12A-12X. In step 6.4 the host processor 20 of a database server 12A-12X compares the user name and password provided in step 6.2 with a user name and password stored in the host processor 12A-12X. It is understood that certain still additional alternate preferred embodiments of the method of the present invention operate without performing the described authentication mechanism or with other authentication actions of steps 5.2, 5.4, 6.2 and 6.4.

In step 6.6 the host processor 20 accepts a filter parameter 41A-41X for inclusion in the local filter parameter 41A-41X from the sys admin as provided via the input device 34 or alternatively via the communications network 6 from the administration computer system 10.

One exemplary filter rule and filter parameter might direct the filter .x to examine the data structures, e.g., objects, associated with the a previously qualified object by a “Colored_Image” relationship, then read each of the visual image data of each object matching the query statement Q, and apply a visual pattern recognition algorithm to each image data of each matching object to find a match for any “Red_Hat” image component. If any such image is found then return, the qualified object to the query system 8; otherwise, the instant host processor 20 proceeds with the search for qualified objects.

In step 6.8 the host processor 20 integrates the filter parameter 41A-41X provided in step 6.6 into the rules of the filter 18A-18X. Instep 6.10 the filter 18A-18X applies the parameter received in step 6.6 to the findings of a search of a search agent 16A-16X. In step 6.12 the host processor 20 of the instant database server 12A-12X returns to alternate processes.

Referring now generally to the Figures and particularly to FIG. 7. FIG. 7 is a format diagram of the query statement Q consisting of a header field Q 1, a search range field Q2, a predicate field Q3, a user identification and priority field Q4, additional data fields Q5, and a tail field Q6. The query statement may, in certain still alternate preferred embodiments of the method of the present invention, be formatted in accordance with Internet Protocol/Transmission Communications Protocol or other suitable transmissions protocols or standards known in the art.

The header field Q1 includes a sender network address in a sender data field Q1S, and one or more addressee network addresses in each of one or more addressee data fields Q1A. The user identification and priority field Q4 may contain information associated with the user who originally issued the query request, such as a priority level, authorization level, or access level of the user.

Referring now generally to the Figures and particularly to FIGS. 2 and 8, FIG. 8 is a schematic diagram of the host processor 20 of the query system 8, the servers 12A-12X, and the administration computer system 10. The host processor 20 includes a central processing unit 46, an internal communications bus 48, a system memory 50, a network interface 52, a video device interface 54, an input device interface 56, and an electronic media reader 58. The central processing unit 46 may be or comprise a PENTIUM™ microprocessor or other suitable processing unit known in the art. The internal communications bus 48 bi-directionally communicatively couples the central processing unit 46, the system memory 50, the network interface 52, the video device interface 54, the input device interface 56, and the electronic media reader 58. The system memory 50 may store both data structures and executable software programs, and make the stored data structures and software executable programs to the central processing unit 46 via the internal communications bus 48. Where the host processor 20 is installed in a database server 12A-12X, the system memory 50 stored one or more databases 14A-14X and a DBMS 40. The DBMS 40 of each database server is configured to apply a search agent 16A-16X, and optionally a configurable software filter 18A-18X, to one or more databases 14A-14X stored in the system memory 50.

The network interface 52 is bi-directionally communicatively coupled with the electronics communications network 6 and enables the communications of query statements Q and search findings between the query system 8 and the database servers 12A-12X.

The video device interface 54 is bi-directionally communicatively coupled with the display device 42 and enables the visual presentation of information, to include findings from database searches, to be visually presented to a user via the video screen 44.

The input device interface 56 is communicatively coupled with the input device 34 and enables the user to input query requests and otherwise interact with the host processor 20.

The electronic media reader 58 is configured to read machine-executable instructions from a computer-readable medium 60, wherein the machine-executable instructions direct the host processor to perform one or more of the steps of the method of the present invention.

One or more search agent 16A-16X or search agent filter 18A-18X may be user provided by means of inputting the instant search engine 16A-16X or filter 18A-18X to a database server 12A-12X via the IT network 2, the query system 8, and/or the computer-readable medium 60 in combination or as a sole source of machine-executable software code.

The terms “computer-readable medium” and “computer-readable media” as used herein refer to any suitable medium known in the art that participates in providing instructions to the IT network 2, the communications network 6, the query system 8, the administration computer system 10, and/or one or more database servers 12A-12X for execution. Such a medium may take many forms, including but not limited to, non-volatile media, volatile media, and transmission media. Non-volatile media includes, for example, optical or magnetic disks, such as may be comprised within the system memory 50.

Volatile media includes dynamic memory. Transmission media includes coaxial cables, copper wire and fiber optics. Transmission media can also take the form of acoustic or light waves, such as those generated during radio wave and infrared data communications.

Common forms of computer-readable media 60 include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer system 8, 10, 12A-12X can read.

Various forms of computer readable media 60 may be involved in carrying one or more sequences of one or more instructions to the network for execution. For example, the instructions may initially be carried on a magnetic disk of a remote server 12A-12X. The remote server 12A-12X can load the instructions into its dynamic memory and send the instructions over a telephone line using a modem. A modem local to or communicatively linked with the IT network 2 can receive the data on the telephone line and use an infra-red transmitter to convert the data to an infra-red signal. An infrared detector can receive the data carried in the infrared signal and appropriate circuitry can provide the data to the IT network 2.

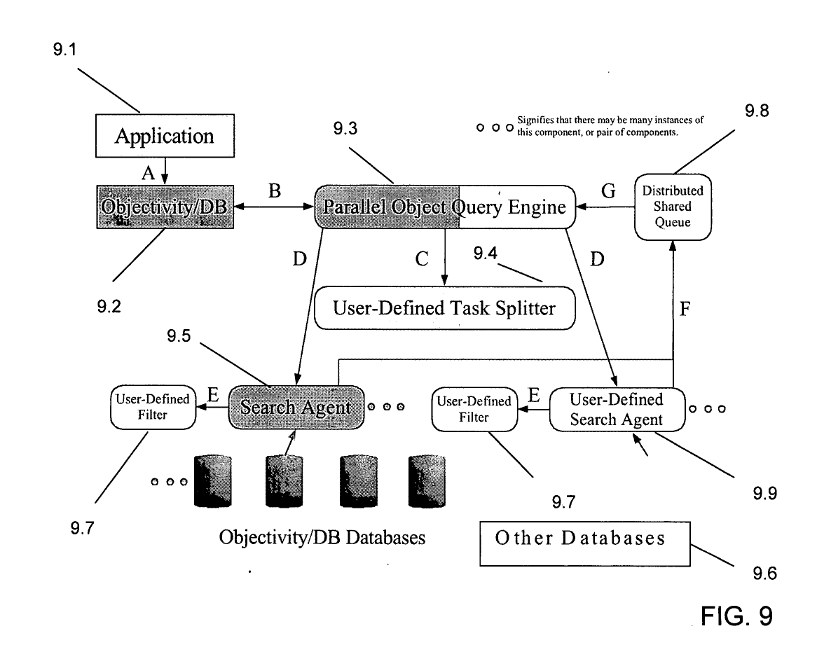

Referring now generally to the Figures and particularly to FIG. 9, FIG. 9 is a schematic of a second alternate embodiment of the method of the present invention (hereafter “second method”) that includes the following three kinds of software components:
a user's application and configurable or user-defined components;
an Objectivity/DB runtime library as marketed by Objectivity, Inc. of Mt. View, Calif.; and
an Objectivity/DB Parallel Object Query Engine as marketed by Objectivity, Inc. of Mt. View, Calif.

Each box 9.1-9.9 in the schematic FIG. 9 represents a component 9.1-9.9 of a computer process or thread, i.e., a sub-process controlled by a process, or a data structure. The components 9.1-9.9 may reside on separate (distributed) processors 20 of the IT network 2. Each line A-G represents an interface A-G between the components. One component 9.1-9.9 may cause or call another component 9.1-9.9 to perform a task regulated by supplied parameters. The called component 9.1-9.9 will generally return one or more results to the component 9.1-9.9 that called the executing component 9.1-9.9.

The flow of the second method may include one or more of the following actions:
a) The software application 9.1 uses an interface A to call a database 9.2 to perform a query. The database 9.2 comprises software objects assigned to one of a plurality of containers. The database 9.2 may comprise an Objectivity/DB runtime library as marketed by Objectivity, Inc. of Mt. View, Calif. The application 9.1 specifies the range of the query (a federated database, a database, a container of objects within a database, or a collection of objects). The application 9.1 also supplies a predicate, such as “Age greater than 100”, to qualify the objects to be returned. The application 9.1 then loops, calling the database 9.2 to obtain successive qualified objects. This query mechanism (setting up conditions and then looping through successive objects) is called an iterator.
b) If the range of the query is a single container of objects then the database 9.2 performs the search for the objects, filters the objects according to the optional predicate and then returns each object to the application 9.1. The application 9.1 may then apply other filters before proceeding with other operations or a current task.
c) If the range of the query is not a single container of objects then the database 9.2 might pass the range of the query and the predicate to a parallel object query engine 9.3 using interface B. The parallel object query engine 9.3 may comprise an Objectivity/DB Parallel Object Query Engine as marketed by Objectivity, Inc. of Mt. View, Calif. The database 9.2 then waits for responses from the parallel object query engine 9.3 (hereafter “POQE” 9.3) until it receives a response indicating that there are no more results. Every time the database 9.2 receives a result from the POQE 9.3 the database 9.2 returns the corresponding object to the application 9.1 using interface A. When there are no more results the POQE 9.3 sends a “No more objects” response back to the application 9.1 using the interface A.
d) When the POQE 9.3 is called by the database 9.2 the POQE 9.3 immediately uses interface C to call a user-defined task splitter 9.4 to determine how to split the query across multiple search agents 9.5. The database 9.2 stores objects inside of containers inside of local databases 14A-14X inside of a federated database 4. Each search agent 9.5 executes a part of the query, generally targeting a single container. For example, suppose that the federated database 4 contains Person objects, with one object per Person. The Person objects might be grouped within containers, with each container representing a single village, town or city. Each container might be grouped within a single database, representing a country. If the query predicate mentions “Switzerland” then the task splitter 9.4 will determine how many containers there are in that database 14A-14X and will then supply a list of containers to the POQE 9.3. Alternatively, a search agent 9.5 may target an external database 9.6.
e) The POQE 9.3 may use an interface D to call search agents 9.5, allocating a single container or database to each search agent 9.5, directing one or more selected search agents 9.5 to perform the search and apply any remaining components of the query predicate. There may be more target containers or databases than there are search agents 9.5 (which are configurable by the application 9.1 or a system administrator), so the POQE 9.3 will schedule the search agents 9.5 on an “as-available” basis until all target containers have been examined.
f) Each search agent 9.5 scans its target container or database and uses an interface E to call a user-defined filter 9.7. The search agent 9.5 then uses an interface F to return the object identifier of a qualified object, or the actual object, or an object synthesized from some external database 9.6, to a distributed shared queue 9.8 owned by the POQE 9.3.
g) After the POQE 9.3 has dispatched the search agents 9.5 the POQE 9.3 may check the distributed shared queue 9.8 for results (object identifiers or objects) using an interface G. The POQE 9.3 may then return the object identifier or the actual object to a kernel of the database 9.2, using the interface B. When no more qualified objects can be found the POQE 9.3 may use the interface B to send a “No more objects” response to the kernel of the database 9.2.
h) The task splitters 9.4 may include algorithms for choosing containers based on time slices, geographical region and object class instance location. It is understood that the user may supply or define a user-defined filter 9.7 for use in filtering the findings of a search agent 9.5 prior to communication of the findings to the application 9.1. It is further understood that one or more search agents 9.5 may alternately be a user-defined search agent 9.9.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore be determined with reference to the knowledge of one skilled in the art and in light of the disclosures presented above.

I claim:

1. In an information technology system containing a plurality of data structures, each data structure comprising a unique identifier and at least one data element, a method for selecting data structures meeting a criteria, the method comprising:
a. Enabling a user to direct the information technology system to assign each of a plurality of search agents to search the plurality of data structures in accordance with user provided tasking rules;
b. Accepting a query, the query specifying a criteria for comparison with the at least one data element; and
c. Tasking at least two search agents to each search a uniquely delineated subset of the plurality of data structures, the delineation effected in accordance with the user provided tasking rules.

2. The method of claim 2, wherein the plurality of data structures comprises a relational database.

3. The method of claim 2, wherein the plurality of data structures comprises an object database, and a subset of the plurality of data structures are software objects.

4. The method of claim 3, wherein the plurality of software objects are clustered into unique containers.

5. The method of claim 3, wherein the plurality of data structures further comprises a relational database.

6. The method of claim one, the method further comprising:
a. Integrating a user provided search agent rule into the information technology system; and
b. Tasking the user provided search agent rule in accordance with the user provided tasking rules.

7. The method of claim 1, the method further comprising:
a. Integrating a user provided filter parameter into the information. technology system; and
b. Tasking at least one search agent to apply the user provided filter parameter in accordance with the user provided tasking rules.

8. The method of claim 1, wherein the information technology system comprises a plurality of memory storage equipments, the plurality of memory storage equipments communicatively coupled within the information technology system, and the data structures distributed among the plurality of data storage equipments.

9. A method for searching a software database, the method comprising:
a. Receiving a search query;
b. Converting the search query into a Boolean algorithm;
c. Assigning the Boolean algorithm to at least two search agents in accordance with a user defined search agent assignment rules set;
d. Searching the software database with the at least two search agents; and
e. Reporting all data structures of the software database found by the at least two search agents to a user.

10. The method of claim 9, wherein at least one of the at least two search agents is a user provided search agent.

11. The method of claim 9, wherein at least one of the at least two search agents applies a user provided filter.

12. The method of claim 9, wherein the plurality of data structures comprises a relational database.

13. The method of claim 9, wherein the plurality of data structures comprises an object database, and a subset of the plurality of data structures are software objects.

14. The method of claim 13, wherein the plurality of software objects are clustered into unique containers.

15. The method of claim 13, wherein the plurality of data structures further comprises a relational database.

16. A computer-readable medium, the medium containing machine-readable instructions for directing an information technology system to execute a data search method, the search method comprising:
a. Accept user provided search agent assignment rules;
b. Incorporate the user provided search agent assignment rules into an a search agent task module;
c. Accept a search query;
d. Convert the search query into a Boolean algorithm;
e. Assign the Boolean algorithm to at least two search agents in accordance with the user provided search agent assignment rules;
f. Searching a software database with the user provided at least two search agents, the at least two search agents including the user provided search agent; and
g. Reporting all data structures of the software database found by the at least two search agents to a user.

17. The computer-readable medium of claim 16, wherein at least one search agent of the at least two search agents comprises a user provided filter.

18. The computer-readable medium of claim 16, wherein at least one search agent of the at least two search agents is structured and directed to search an object database.

19. The computer-readable medium of claim 18, the object database includes containers, each container including software objects.

20. The computer-readable medium of claim 16, wherein the at least one search agent of the at least two search agents is structured and directed to search a relational database.
